(19) United States
(12) Patent Application Publication
(10) Pub. No.: US 2013/0011609 A1
(43) Pub. Date: Jan. 10, 2013

(54) Coating Method and Coated Articles

(75) Inventors: Joe Comitale, Mississauga (CA); Duane Farley, Mississauga (CA); Lewis Andrews, Mississauga (CA)

(73) Assignee: THE LOXCREEN COMPANY, INC., West Columbia, SC (US)

(21) Appl. No.: 13/542,826

(22) Filed: Jul. 6, 2012

Related U.S. Application Data
(60) Provisional application No. 61/505,638, filed on Jul. 8, 2011.

(51) Int. Cl. B32B 3/10; B05D 7/02

(52) U.S. Cl. 428/141; 427/393.5

(57) ABSTRACT

The present invention provides an improved uncoupling membrane for use between a top coat of mortar in which a tile layer is set and a base coat of mortar applied to a substrate surface. The membrane being of the type including a dimpled plastic layer, the dimples defining, on one side of the membrane, a number of depressions into which the top coat extends in use and, on the other side of the membrane, a number of protuberances. The improvement may include a polymeric coating overlying the plastic layer and to which the top coat of mortar adheres in use.

### CROSS-REFERENCE TO RELATED APPLICATION

This application claims priority to co-pending U.S. Provisional Patent Application Ser. No. 61/505,638, entitled “COATING METHOD AND COATED ARTICLES”, filed Jul. 8, 2011 and entirely incorporated herein by reference.

### FIELD

This invention relates generally to the field of hard surface coverings for floors and walls.

### BACKGROUND OF THE INVENTION

It is known to provide for connection between mortar and plastic substrates via a flexible mat that is secured to the plastic substrate.

One common application of this technology is in the field of uncoupling membranes.

An uncoupling membrane is a flexible panel that is commonly interposed between a base coat of mortar that is laid upon a substrate such as a floor or wall and a top coat of mortar which receives a hard surface covering, such as tile.

By way of background, many floors are susceptible to movement in view of dynamic loads and expansion and contraction associated with variations in ambient moisture and temperature. A tile covering applied with a simple mortar bed to a floor of this type would necessarily crack. This is avoided by the uncoupling membrane, which allows for limited movement of the hard surface covering relative to the floor substrate.

In a typical embodiment of an uncoupling membrane, the panel includes a dimpled HDPE plastic sheet, with undercut depressions defined by the dimples, and a flexible fleece mat secured to the surface of the plastic sheet opposite to that which has the depressions defined therein.

With respect to this embodiment, in use: the top coat of mortar mechanically interlocks, via the undercuts, with the plastic sheet; the base coat of mortar mechanically interlocks with the fleece; and the fleece stretches, flexes, releases and shears, to accommodate the relative movement that would otherwise result in cracking, while maintaining a grip upon both the plastic sheet and the base coat. Although it is known for the fleece mats to be provided with visible perforations, it is in fact typical for the fleece to be substantially impermeable in use to the mortar. Thus, the channels defined in the sheet on the side opposite the depressions remain substantially free of mortar in use, to permit expansion, contraction and flexure of the plastic sheet.

In other known and conventional embodiments, the dimples have no undercuts. In these embodiments, another flexible mat is provided and secured in overlying relation to the depressions. This mat has a function generally analogous to that previous described, but it is conventional for this mat to have a relatively more open texture, thereby to ensure that the depressions are fully occupied with mortar in use; this ensures that the floor covering is supported upon the substrate by mortar “plugs” rather than simply the plastic dimples themselves.

Another known application of this technology is in the field of shower drain kits: it is known to secure, to the bonding flange of a shower drain, a mat similar to that used to secure the plastic layer to the base coat in uncoupling membrane applications.

### SUMMARY OF THE INVENTION

An improved uncoupling membrane, for use between a top coat of mortar in which a tile layer is set and a base coat of mortar applied to a substrate surface, forms one aspect of the invention. The membrane is of the type including a dimpled plastic layer, the dimples defining, on one side of the membrane, a plurality of depressions into which the top coat extends in use and, on the other side of the membrane, a plurality of protuberances. The improvement comprises: a polymeric coating overlying the plastic layer and to which said top coat of mortar adheres in use.

According to another aspect of the invention, the coating can be elastomeric.

According to another aspect of the invention, the coating can be a latex.

According to another aspect of the invention, the coating can be a styrene butadiene block polymer.

According to another aspect of the invention, the coating can be a layer of the compound sold by Flextile Inc. of Toronto, Canada under the stock number WP980.

According to another aspect of the invention, the membrane can further include a mat secured to the protuberances to define, between the mat and the plastic layer, void space separating the protuberances from one another.

According to another aspect of the invention, in use, the void space can be substantially free of mortar and the depressions are substantially fully occupied with mortar.

A method for rendering a plastic surface amenable to bonding with mortar forms another aspect of the invention. The method comprises the steps of: applying to said plastic surface a coating of a styrene butadiene block copolymer; and allowing the coating to cure, at least in part, into an elastomer.

According to another aspect of the inventive method, the coating can be sprayed.

According to another aspect of the inventive method, the coating can be sprayed with an airless sprayer.

According to another aspect of the inventive method, the coating can be sprayed with a 615 spray tip.

According to another aspect of the inventive method, the coating can be applied at a rate of 15-20 ml per square foot of plastic surface.

According to another aspect of the inventive method, the coating can be the compound sold by Flextile Inc. of Toronto, Canada under the stock number WP980.

An improved uncoupling membrane forms another aspect of the invention. The membrane is for use between: (i) a top coat of mortar in which a layer of hard surface covering material is set is set, the hard surface covering material being selected from tile and stone; and (ii) a base coat of mortar applied to a substrate surface, the membrane being of the type including a dimpled plastic layer, the dimples defining, on one side of the membrane, a plurality of depressions into which the top coat extends in use and, on the other side of the membrane, a plurality of protuberances. The improvement comprises: a polymeric coating overlying the plastic layer and to which said top coat of mortar adheres in use.

Other features and aspects of the present invention will become apparent from the following detailed description considered in connection with the accompanying drawings, the latter being briefly described hereinafter.

### BRIEF DESCRIPTION OF THE DRAWINGS

In the drawings, wherein similar reference characters denote similar elements throughout the several views:

FIG. 1 is a cross section of apparatus according to the exemplary embodiment in use with ceramic tiles and mortar on a floor;

FIG. 2 is an enlarged elevational view of a portion of the apparatus shown in FIG. 1;

FIG. 3 is a sectional view along line 3-3 of FIG. 2;

FIG. 4 is a perspective view of the structure of FIG. 2

FIG. 5 is a FTIR spectrum of the cured coating;

FIG. 6A is a view similar to FIG. 5; and

FIG. 6B is a FTIR spectrum of the product sold under the trade-mark FINAPRENE411 by Fina Oil & Chemical.

### DESCRIPTION OF THE EXEMPLARY EMBODIMENT

### Structure

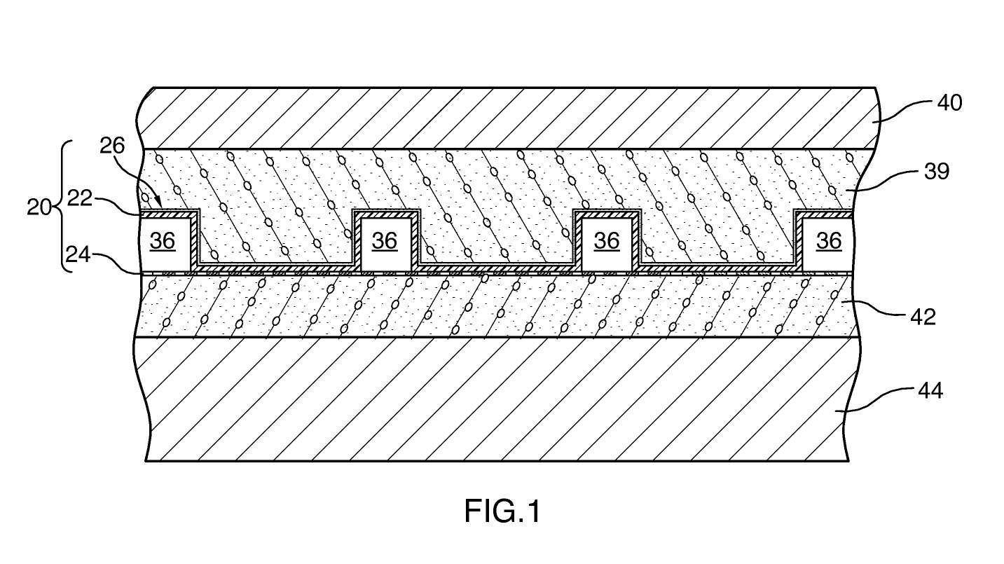

An uncoupling membrane which forms an exemplary embodiment of the present invention is shown in use in FIG. 1 and identified with reference numeral 20.

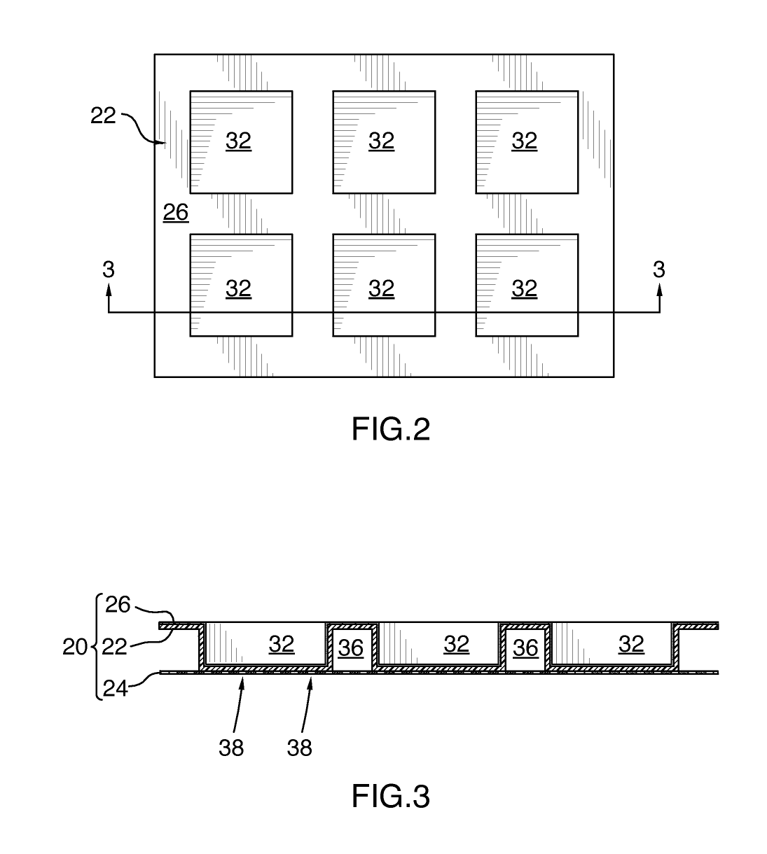

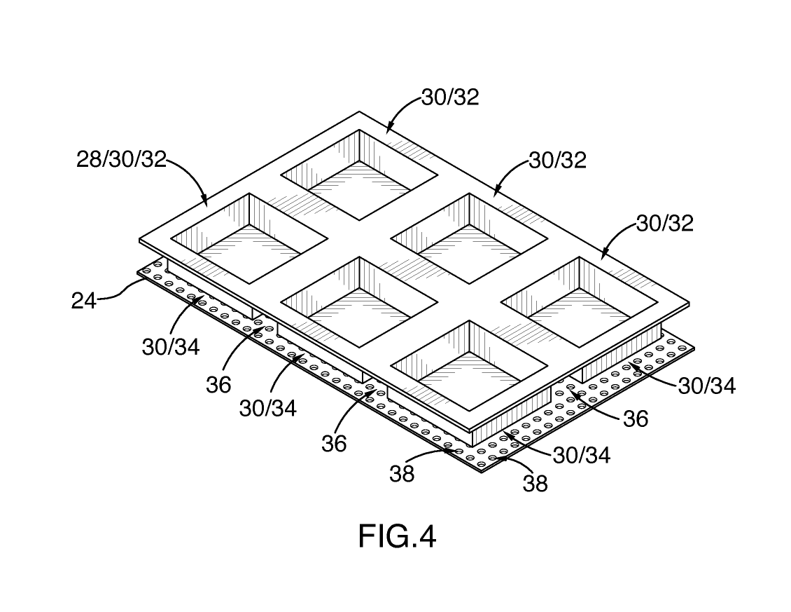

The uncoupling membrane 20, as will be best seen in FIGS. 2-4, comprises a sheet 22, a mat 24 and a coating 26.

The sheet 22 will be understood to be HDPE plastic, and to have a plurality of dimples 28 defined therein, for example, by vacuum forming. The presence of the dimples 30 define, on one side of the sheet 22, a plurality of depressions 32 and, on the other side, a plurality of protuberances 34.

The mat 24 is a fleece with fine perforations 38 and which is glued or partially fused to the side of the sheet 22 opposite that which in which the depressions 32 are defined to define a void space 36 surrounding each protuberance 34 and arranged in a lattice.

This coating 26 is a layer of polymeric elastomer overlying the side of sheet 22 in which the depressions 32 are formed. In this embodiment, the elastomer is a styrene copolymer latex sold by Flextile Inc. of Toronto, Canada under the stock number WP980.

### Nature of the Composition

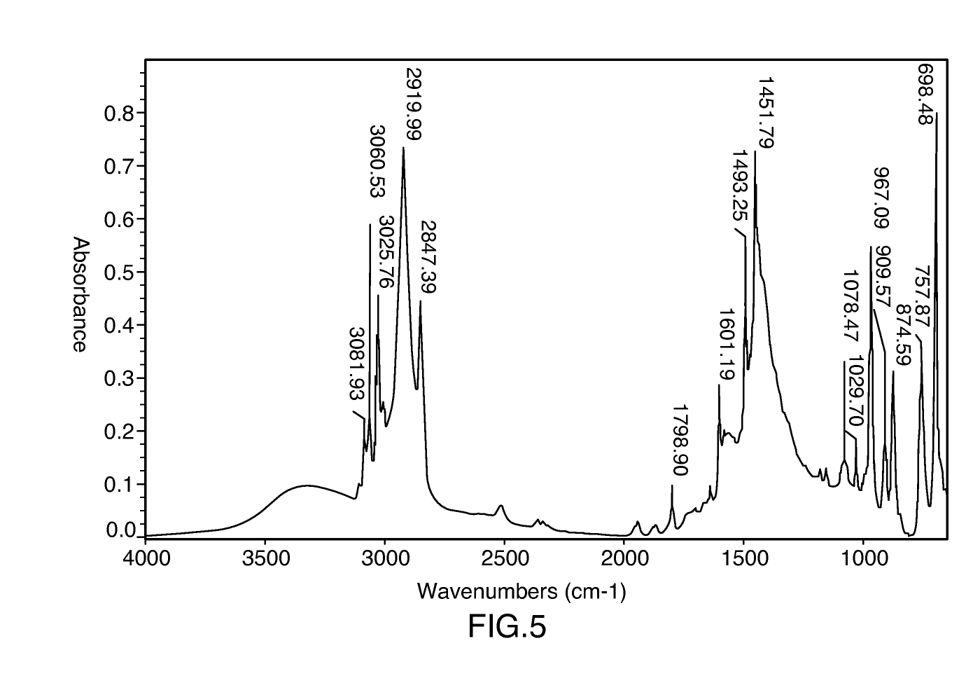

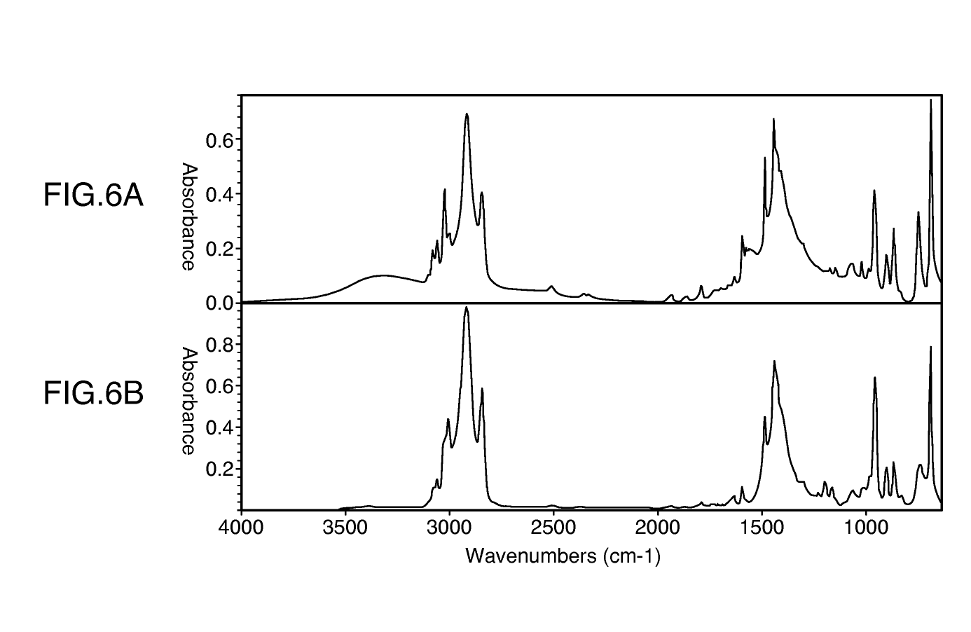

A sample of WP980 was smeared onto a KCL plate and allowed to cure. The cured material was analysed by Fourier Transform Infrared (FTIR) spectroscopy; the spectrum obtained is reproduced as FIG. 5. Based on the peak assignments in the spectrum, the cured elastomer is generically identifiable as an aromatic/alkene hydrocarbon type of material. The spectrum matches the spectrum of a known styrene-butadiene block copolymer sold under the trade-mark FINAPRENE 411 by Fina Oil & Chemical, as shown by FIGS. 6A and 6B.

Thermal Gravimetric Analysis was further carried out to determine the amount of the components present in the coating 26. The composition of the coating 26, determined on the basis of uncured resin, was found to be:
volatiles 39.8%
elastomer 42.2%
carbonaceous residue (possibly carbon black) 6.2%
inert materials 11.8%
non-carbonaceous oxidizables 0.4%

### Use

In use, as shown in FIG. 1, this product 20 is interposed between a top coat 39 of mortar in which a tile layer 40 is set and a base coat of mortar 42 applied to a substrate surface 44, in the manner in which conventional uncoupling membranes are used. As in the conventional application, the fleece mat 24 is resistant to mortar flow, such that the voice spaces 36 surrounding each protuberance 34 are substantially free of mortar [to permit compression and extension in the sheet] and the depressions 32 are substantially fully occupied with mortar, to form mortar plugs and provide stable support to the tile 40 to permit foot traffic, etc. The dimples are designed in a conventional fashion, to maximize point load capacity of the membrane, while allowing sufficient voids between mortar plugs to allow movement.

However, whereas in conventional uncoupling membranes, the top coat is held to the plastic sheet by re-entrant edges on the mortar plugs that occupy the depressions and mechanically engage with the plastic sheet, or via mechanical engagement between the mat that becomes embedded in the mortar plugs in use, in the present invention, the top coat 39 is held by virtue of its adherence to the coating 26.

### Manufacture

A suitable methodology for applying the coating involves a 110 volt Graco 390 airless sprayer with a 615 spray tip nozzle and with filters installed [1 in pump, 1 in spray gun] as per manufacturers instructions [none of the foregoing shown]. With: the sprayer so prepared; the pick up hose in communication with a supply of the elastomeric material in resin form; and the sprayer at operating pressure, an even application of the resin, at a rate between 15 and 20 ml per square foot or surface to be coated, has been found to provide good adhesion.

The resin can be cured, in any conventional way, to the extent necessary suitable for subsequent use: the coating need only be dry to the touch to function as a suitable bonding agent for mortar, but in circumstances wherein a plurality of the coated products will be stacked upon one another, or wherein a coated product will be rolled upon itself, and stored for a period of time during the normal retail cycle, it will be advisable to allow the rein to more fully cure to avoid undesired self-adhesion.

### Utility

### Adhesive Strength

The membrane 20 was applied to a 16″×16″×2″ concrete block using Keralastic thin-set mortar and a ¼″×⅜″ square notch trowel. Ten 2″×2″ porcelain mosaic tile specimens were bonded to the membrane with Mapei Kerabond and Keralastic thin-set mortar using a ¼″×⅜″ square-notch trowel. Thereafter, Laticrete 1500 series sanded grout was applied. The blocks were cured for 28 days before testing. Testing was carried out in accordance with ISO 13007-2. Average tensile adhesion strength was 0.4 N/mm2. Cohesive failure within the adhesive 26 accounted for 70% of the failure mode; the remaining 30% was associated with adhesive failure between the adhesive 26 and the sheet 22.

### Crack Resistance

The membrane 20 was applied, using Keralastic thin-set mortar and a ¼″×⅜″ square notch trowel to the faces of two 10″×8″×2″ concrete blocks butted and strapped together to form a 20″×8″×2″ unit. A pattern of 4″×8″×½″ quarry tiles (detailed by ANSI A118.12) was bonded to the membrane 20 with Mapei Kerabond and Keralastic thin-set mortar using a ¼″×3.8″ square-notch trowel. The system was allowed to cure for 24 hours, and then grouted using Laticrete 1500 series sanded grout. The blocks were cured for an additional 28 days. Tests in accordance with ANSI A118.12 deem the membrane “high performance”.

Mechanical testing

The membrane 20 was bonded to the faces of three 6″×6″×2″ concrete blocks using Keralastic thin-set mortar and a ¼×⅜″ square notch trowel. Three 12″×12″ unglazed porcelain tiles were cut to 6″×6″ and bonded to the membrane 20 with Mapei Kerabond and Keralastic thin-set mortar. The thin-set mortar was buttered on the back of the tiles to ensure maximum coverage and ⅛″ spacers were used to provide a uniform bond coat. Thereafter, Laticrete 1500 series sanded grout was applied. The blocks were cured for an additional 28 days. Various tests in accordance with ANSI A118.12 were carried out, and the results, which all exceed the standard, are as shown below:

| | | |
|---|---|---|
| 7 day shear strength (5.1.3) | 106 | psi |
| 7 day water immersion shear strength (5.1.4) | 68 | psi |
| 4 week shear strength (5.1.5) | 93 | psi |
| @ 0.0625 inch deflection | 68 | ps |
| @ 0.125 inch deflection | 76 | psi |
| Accelerate aging shear strength (5.1.6) | 98 | psi |
| @ 0.0625 inch deflection | 97 | psi |
| @ 0.125 inch deflection | 72 | psi |
| Point load test, average of 3 tests (5.2) | 1232 | lbf |

### Variants

Whereas but a single embodiment is herein shown and described, it will be appreciated that variations are possible.

For example, whereas square dimples are shown and arranged in a checkerboard fashion, the dimples could, for example, be round or triangular. Further, a simple checker board or lattice shape is not necessary. The dimples can, for example, themselves be reverse-dimpled; all that is required is that the structure allow for expansion, contraction and flexure in use.

Further, whereas the dimples shown are generally columnar, they could taper or flare.

As well, whereas the mat 24 that mechanically engages with the base coat is indicated to be a fleece with small apertures, this is not strictly necessary: a fleece with no apertures visible to the naked eye could also be used.

Additionally, whereas a specific polymeric compound is described as useful, substitutions and variations are possible. Also known to be useful are: the styrene copolymer latex sold by Laticrete International Inc. as LATICRETE Blue 92 Anti Fracture Membrane; the sealant sold by Custom Building Products under the Product Name RedGard Waterproofing and Crack Prevention Membrane; and the carboxylated styrene butadiene polymer sold by MAPEI under the Material Name MAPELASTIC AQUADEFENSE.

Further, whereas the coating is described in relation to uncoupling membrane, the coating has been found to be a useful substitute for the mat that is conventionally used on the bonding flange of a shower drain and has also been found to be usefully applied to the foam preforms of the type that are used as the tile-receiving substrate for shower pan construction in certain applications. The invention can also be embodied as a replacement for the top scrim for waterproofing, plastering and ceramic tiles.

Whereas tiles are mentioned, it will be understood that the invention also has application with natural stone [marble, granite, etc.] and slabs.

Yet further, although not illustrated, it will be readily understood that the uncoupling membrane of the present invention could, for example, be arranged with pathways and channels for heating cable or conduit.

Accordingly, the invention should be understood as limited only by the accompanying claims, purposively construed.

We claim:

1. An improved uncoupling membrane for use between a top coat of mortar in which a tile layer is set and a base coat of mortar applied to a substrate surface, the membrane being of the type including a dimpled plastic layer, the dimples defining, on one side of the membrane, a plurality of depressions into which the top coat extends in use and, on the other side of the membrane, a plurality of protuberances, the improvement comprising:
a polymeric coating overlying the plastic layer and to which said top coat of mortar adheres in use.

2. An improved membrane according to claim 1, wherein the coating is elastomeric.

3. An improved membrane according to claim 2, wherein the coating is a latex.

4. An improved membrane according to claim 2, wherein the coating is a styrene butadiene block polymer.

5. An improved membrane according to claim 3, wherein the coating is a layer of the compound sold by Flextile Inc. of Toronto, Canada under the stock number WP980.

6. An improved membrane according to claim 1, wherein the membrane further includes a mat secured to the protuberances to define, between the mat and the plastic layer, void space separating the protuberances from one another.

7. An improved membrane according to claim 6, wherein, in use, the void space is substantially free of mortar and the depressions are substantially fully occupied with mortar.

8. A method for rendering a plastic surface amenable to bonding with mortar, the method comprising the steps of:
applying to said plastic surface a coating of a styrene butadiene block copolymer allowing the coating to cure, at least in part, into an elastomer.

9. A method according to claim 8, wherein the coating is sprayed.

10. A method according to claim 9, wherein the coating is sprayed with an airless sprayer.

11. A method according to claim 10, wherein the coating is sprayed with a 615 spray tip.

12. A method according to claim 11, wherein the coating is applied at a rate of 15-20 ml per square foot of plastic surface.

13. A method according to claim 8, wherein the coating is the compound sold by Flextile Inc. of Toronto, Canada under the stock number WP980.

14. An improved uncoupling membrane for use between a top coat of mortar in which a layer of hard surface covering material is set is set, the hard surface covering material being selected from tile and stone; and
a base coat of mortar applied to a substrate surface, the membrane being of the type including a dimpled plastic layer, the dimples defining, on one side of the membrane, a plurality of depressions into which the top coat extends in use and, on the other side of the membrane, a plurality of protuberances, the improvement comprising:
a polymeric coating overlying the plastic layer and to which said top coat of mortar adheres in use.
